(19) United States
(12) Patent Application Publication
(10) Pub. No.: US 2017/0219411 A1
(43) Pub. Date: Aug. 3, 2017

(54) FUEL LEVEL SENSOR APPARATUS AND SUPPORT STRUCTURE THEREFOR

(71) Applicant: JAGUAR LAND ROVER LIMITED, Warwickshire (GB)

(72) Inventor: Raymond Doherty, Whitley, Coventry, Warwickshire (GB)

(21) Appl. No.: 15/124,120

(22) PCT Filed: Mar. 6, 2015
(86) PCT No.: PCT/EP2015/054739

§ 371 Date: Sep. 7, 2016

(30) Foreign Application Priority Data
Mar. 7, 2014 (GB) 1404025.7

(51) Int. Cl. G01F 23/36; B60K 15/073

(52) U.S. Cl. CPC G01F 23/363; B60K 15/073; B60K 2015/0638

(57) ABSTRACT

There is provided a liquid level sensor apparatus that has particular and beneficial application in a fuel tank, such as a saddle-tank used in automotive vehicles comprising first and second fuel compartments. The liquid level sensor apparatus is for determining a level or quantity of fuel therein. The liquid level sensor apparatus comprises means for issuing an electrical signal indicative of a level or quantity of liquid, such as a sender unit comprising a motion-responsive potentiometer. Additionally there is provided a first float assembly that is moveable in response to a first liquid level. The first float assembly is coupled directly to said means such that in response to movement of the first float assembly an electrical characteristic of said means is affected and an electrical signal issued by said means is indicative of said first liquid level. Furthermore, there is provided a second float assembly that is moveable in response to a second liquid level. The second float assembly is indirectly coupled to said means and in such a way that in response to movement of the second float assembly an electrical characteristic of said means is affected and an electrical signal issued by said means is indicative of said second liquid level.

### TECHNICAL FIELD

The present invention relates to a fuel level sensor apparatus, to a support structure therefor, to a fuel tank, to a method for determining the quantity of fuel in a saddle-type fuel tank and to a vehicle. More particularly, but not exclusively, the invention relates to a fuel level sensor apparatus having two floats each mechanically coupled to a single fuel level sender unit. The invention finds advantageous application in vehicles comprising a fuel tank comprising two or more compartments, such as saddle-type fuel tanks.

Aspects of the invention relate to a fuel level sensor apparatus, to a support structure, to a fuel tank, and to a vehicle.

### BACKGROUND

Modern day motor vehicles with drivable rear wheels typically possess a fuel tank which straddles the prop shaft and exhaust systems that are installed centrally in the motor vehicle. This type of fuel tank is known as a “saddle tank”. A saddle tank typically has two compartments connected over the prop shaft by a narrow passageway, known as the saddle or weir point.

Typically, one of the compartments of a saddle fuel tank contains the fuel delivery pump and is known as the “active compartment”. The active compartment requires a sealable opening for installation and servicing of the fuel delivery pump. Typically, the other compartment does not contain a fuel delivery pump and hence is known as the “passive compartment”. A transfer means, such as a suction tube, is provided in the passive compartment for transferring fuel from the passive side to the active side for the fuel delivery pump to pick up.

To allow for accurate fuel level measurement, a fuel level sensor apparatus is installed in each compartment of the saddle fuel tank. In this way, the varying levels of fuel which may exist in each of the active and passive compartments can be accurately monitored. Typically a fuel level sensor apparatus comprises a float arm having a float that is mechanically coupled to a sender unit. The sender unit comprises circuitry (for example electric or magnetic) that is responsive to the position of the float and that is configured to issue a signal that is indicative of the quantity of fuel or the fuel level in the compartment in which it is installed.

Typically, such saddle fuel tanks comprise access means (sealable openings) associated with the active and the passive compartment to enable servicing of the two fuel level sensor units that are required. The provision of two access means is convenient for servicing and repair. However, in passenger vehicles that are required to comply with lowest evaporative emission regulations, it is not a viable option to have two access means (one for each of the active and passive compartments). A further consideration is that, due to requirements for improved rear seat comfort, the weir point or connection between the active compartment and the passive compartment is very limited in section. Hence it is extremely difficult, if not impossible, to access a fuel level sensor apparatus and particularly the sender unit thereof in the passive compartment from the access means associated with the active compartment (or vice versa) to allow for servicing of both fuel level sensor apparatus via a single access means associated with the active side. As such it is desirable to improve the ability to conduct service and repair of the fuel level sensor apparatus via a single access means associated with only one of the two compartments.

The present invention seeks to provide an improvement in the field of fuel level sensors and has particular application for vehicles having fuel tanks with two or more compartments. However, the invention may also find advantageous application in fuel tanks having only one compartment of a size that may benefit from two or more fuel level measurements being taken at spaced locations along the compartment. The invention may be utilised in applications other than for vehicles. For example, it is foreseen that the invention may have application in sensing liquid levels in tanks or other containers that store liquids other than fuel.

### SUMMARY OF THE INVENTION

Aspects of the invention provide a fuel level sensor apparatus, a support structure for use in a fuel level sensor apparatus, a fuel tank, and a vehicle.

According to an aspect of the disclosure for which protection is sought, there is provided a liquid level sensor apparatus for use in a fuel tank for determining a level or quantity of fuel therein, the liquid level sensor apparatus comprising:
(i) means for issuing a signal indicative of a level or quantity of liquid;
(ii) a first float assembly moveable in response to a first liquid level and being coupled directly to said means such that in response to movement of the first float assembly a characteristic of said means is affected and a signal issued by said means is indicative of said first liquid level; and
(iii) a second float assembly moveable in response to a second liquid level and being indirectly coupled to said means such that in response to movement of the second float assembly a characteristic of said means is affected and a signal issued by said means is indicative of said second liquid level.

Optionally, the liquid level sensor apparatus may be dimensioned such that it is suitable for use in a fuel tank comprising a first and a second fuel compartment or such that it is suitable for use in a fuel tank comprising only a single compartment having a shape or dimension such that more than one fuel level measurement at spaced locations is beneficial.

Optionally, said means is positionable in a first fuel compartment and said second float assembly is indirectly coupled thereto via a mechanical linkage structure that is structured and arranged for spanning substantially between a second fuel compartment and a first fuel compartment.

Optionally, said means for issuing a signal issues an electrical signal and comprises a sender unit having electrical circuitry and an actuator coupled thereto, said first float assembly is coupled directly to the actuator for the electrical circuitry such that in response to movement of the first float assembly the actuator is moved and a change in an electrical characteristic of the electrical circuitry is registered; and said second float assembly is indirectly coupled to the sender unit such that in response to movement of the second float assembly the sender unit is moved and thereby a change in an electrical characteristic of the electrical circuitry is registered.

Optionally, the sender unit comprises a single actuator such that changes in the first and second liquid levels are translated into a change in an electrical characteristic by a single sender unit and wherein said sender unit is configured to issue an electrical signal indicative of a quantity of liquid.

The electrical characteristic may, for example, be resistance and/or voltage, and thereby the sender unit is configured to issue an electrical signal indicative of the quantity of liquid. In this way, when the liquid level sensor is installed in a fuel tank, for example of the “saddle tank”-type, a single electrical signal indicative of the total quantity or relative level of fuel contained within the tank is issued, without the need to have two separate sender units for each compartment of the saddle tank. Maintenance and servicing of the single sender unit of the liquid level sensor apparatus can be carried out from the “active” compartment of the fuel tank.

Optionally, the actuator is a wiper of a potentiometer or is attached to a wiper of a potentiometer and wherein the wiper is slidably and electrically in contact with the electrical circuitry.

Optionally, movement of the actuator creates or changes a magnetic field within the sender unit, or the actuator is connected to a wiper and movement of the wiper creates or changes a magnetic field within the sender unit.

Optionally, the actuator is rotatable and the sender unit is rotatable or the actuator is linearly moveable and the sender unit is linearly moveable.

Optionally, in response to an increase in the first liquid level, the first float assembly causes the actuator to move in a first actuator direction; and in response to an increase in the second liquid level, the second float assembly causes the actuator to move also in the first actuator direction.

Beneficially therefore, when the level sensor apparatus is deployed in a fuel tank, for example, of the “saddle tank” type, as the first and second float assemblies rise and fall with increasing and decreasing fuel levels in the first and second fuel compartments respectively, the actuator position is adjusted and an electrical characteristic of the circuitry affected such that an accurate indication of the total quantity of fuel held in the first and second compartments is issued for use by other vehicle systems.

Optionally, the sender unit is pivotally mounted within the fuel sensor apparatus and is rotatably moveable between a first sender unit position and a second sender unit position.

Beneficially, by pivotally mounting the sender unit (rather than rigidly mounting it in a non-moveable state as is typical), the sender unit can effectively be moved (by the second float assembly) relative to the actuator. As the actuator is directly coupled to the first float assembly and, as such, its position is dictated by the position of the first float assembly, movement of the sender unit has the same effect as holding the sender unit stationary and moving the actuator. In other words an electrical characteristic, for example resistance and/or voltage, is changed by moving the sender unit relative to the actuator. A signal generated and/or issued by the sender unit, based on the electrical characteristic, may change accordingly. Said signal may then be taken to be indicative of the overall fluid level in a fluid container, in particular a fuel tank, and in particular a fluid container or fuel tank with more than one (for example, two) compartment(s).

Optionally, a sender unit is rigidly affixed to a housing assembly; the housing assembly is rotatable, and thereby the sender unit is rotatably moveable between a first sender unit position and a second sender unit position.

Optionally, the liquid level sensor apparatus comprises a balance arm having first and second ends and being shaped and arranged for spanning between first and second fuel compartments of a fuel tank. The balance arm may be pivotally mounted within the liquid level sensor apparatus and the second float assembly may be rigidly coupled to the second end of the balance arm. The first end of the balance arm may be coupled to the sender unit such that movement of the second float assembly in dependence upon the second liquid level causes movement of: the second end of the balance arm; the first end of the balance arm; and the position of the sender unit relative to the actuator.

Optionally, the liquid level sensor apparatus comprises a support frame shaped and arranged for spanning between the first and second compartments of a fuel tank.

Optionally, the balance arm is pivotally mounted to the support frame and the sender unit housing assembly is pivotally mounted to the support frame. A rigid link arm may be coupled to the first end of the balance arm via an articulating means, such as a ball joint or pivot and is positioned and arranged such that movement of the first end of the balance arm causes movement of the rigid link arm, which in turn contacts and thereby moves the sender unit housing assembly or sender unit, which in turn causes movement of the actuator relative to the first float assembly.

Optionally, the liquid level sensor apparatus further comprises two stops for limiting the range of movement of the second float assembly between a first start position and a first stop position. Additionally or alternatively, the liquid level sensor apparatus further comprises two stops for limiting the range of movement of the sender unit between a sender unit start position and a sender unit stop position.

Optionally, the support frame comprises a main member to which the balance arm is pivotally mounted; a first leg for being positioned within a first compartment of a fuel tank; and a second leg for being positioned within a second compartment of a fuel tank. The two stops for limiting the range of movement of the second float assembly may be affixed to the second leg of the support frame. The two stops for limiting the range of movement of the sender unit may be affixed to the first leg of the support frame.

Optionally, the first float assembly comprises a first float attached to a first rigid tether and the second float assembly comprises a second float attached to a second rigid tether. The first and second floats have a size and configuration selected in dependence upon the size and configuration of a fuel tank, or fuel tank compartment, in which they are used. The first and second floats may have a similar or different size and configuration.

According to an aspect, there is provided a support structure for use in a liquid level sensor apparatus according to any relevant preceding paragraph, the support structure comprising:
(i) a support frame shaped and arranged for spanning between a first and a second compartment of a tank and having a main member; a first leg for being positioned within the first compartment of the tank; and a second leg for being positioned within the second compartment of the tank;
(ii) a balance arm moveably mounted to the main member of the support frame; and
(iii) a sender unit housing assembly movably mounted to or proximate to the second leg of the support frame.

Optionally, the balance arm is pivotally mounted to the main member of the support frame and the sender unit housing is pivotally mounted to or proximate to the second leg of the support frame. Optionally, the support structure may comprise a rigid link arm coupled to the first end of the balance arm via an articulating means, such as a ball joint or pivot that is positioned and arranged such that movement of the first end of the balance arm causes movement of the rigid link arm, which in turn contacts and thereby moves the sender unit housing assembly or sender unit.

Optionally, the support structure further comprises:
(i) two stops affixed to the second leg of the support frame for limiting the range of movement of the second float assembly between a first start position and a first stop position; and/or
(ii) a further two stops affixed to the first leg of the support frame for limiting the range of movement of the sender unit housing assembly between a sender unit start position and a sender unit stop position.

According to an aspect, there is provided a fuel tank comprising a fuel compartment and a liquid level sensor apparatus according to any relevant preceding paragraph.

Optionally, the fuel tank is of the saddle tank type and comprises a first fuel compartment connected to a second fuel compartment.

Optionally, the first fuel compartment comprises a sealable access means and the second fuel compartment does not comprise an access means, and wherein the liquid level sensor apparatus is affixed to the fuel tank such that the first float assembly and sender unit are disposed within the first fuel compartment and such that the second float assembly is disposed within the second fuel compartment.

According to a further aspect of the invention for which protection is sought there is provided a method for determining a level or quantity of liquid in a saddle-type fuel tank having an active compartment and a passive compartment, said active compartment and said passive compartment being connected via a passageway, the method comprising:
disposing within the tank a liquid level sensor apparatus comprising a sender unit for issuing a signal indicative of the level or quantity of liquid, a first float assembly, and a second float assembly; and
issuing a signal indicative of the level or quantity of liquid in the tank from said sender unit,

wherein:

the sender unit is disposed in the active compartment and comprises a first part and a second part, the sender unit being configured to issue a signal dependent upon the position of the first part and the second part;

the first float assembly is disposed in the active compartment and is movable in response to the liquid level in the active compartment;

the second float assembly is disposed in the passive compartment and is movable in response to the liquid level in the passive compartment; and

movement of the first float assembly is configured to affect the position of the first part of the sender unit and movement of the second float assembly is configured to affect the second part of the sender unit;

whereby the signal issued by the sender unit is indicative of the total level or quantity of liquid within said active compartment and said passive compartment.

In an embodiment one of the first and second parts of the sender unit may comprise a body of the sender unit, the other of the first and second parts of the sender unit may comprise an actuator of the sender unit, and the sender unit may be configured to issue a signal dependent on the relative positions of the actuator and the body.

In an embodiment, said movement of the first and second parts of the sender unit may comprise rotation.

In an embodiment the liquid level sensor apparatus may further comprise a mechanical linkage structure disposed in said passageway and connected to at least said the second part of the sender unit and said second float assembly.

In an embodiment one of said first and second float assemblies may be directly coupled to said sender unit and one of said first and second float assemblies may be indirectly coupled to said sender unit.

According to a further aspect of the invention for which protection is sought there is provided a saddle-type fuel tank having an active compartment and a passive compartment connected to said active compartment via a passageway, the fuel tank comprising an apparatus for determining the level or quantity of liquid within said fuel tank, the apparatus comprising:
a first float assembly located in the active compartment;
a second float assembly located in the passive compartment; and a sender unit located in the active compartment and comprising a first part and a
second part, the sender unit being configured to issue a signal dependent upon the positions of the first part and the second part,
wherein:

the first float assembly is movable in response to the liquid level in the active compartment;

the second float assembly is movable in response to the liquid level in the passive compartment; and

movement of the first float assembly is configured to affect the position of the first part of the sender unit and movement of the second float assembly is configured to affect the second part of the sender unit;

whereby the signal issued by the sender unit is indicative of the total level or quantity of liquid within said active compartment and said passive compartment.

In some embodiments one of the first and second parts of the sender unit may comprises a body of the sender unit, the other of the first and second parts of the sender unit may comprise an actuator of the sender unit, and the sender unit may be configured to issue a signal dependent on the relative positions of the actuator and the body.

In an embodiment the movement of the first and second parts may comprises rotation.

In an embodiment a mechanical linkage structure may be disposed in said passageway and connected to at least said the second part of the sender unit and said second float assembly. Optionally, said mechanical linkage structure comprises a support structure and a balance arm pivotably connected thereto, the balance arm being further connected to the second part of the sender unit and the second float assembly. lt will be understood that the liquid within the fuel tanks in the context of the present invention will typically be fuel, for example gasoline or diesel.

According to an aspect of the disclosure for which protection is sought, there is provided a vehicle comprising a liquid level sensor apparatus according to any of the relevant preceding paragraphs and/or having a fuel tank according to any of the relevant preceding paragraphs and/or configured to implement a method according to any of the relevant preceding paragraphs.

The skilled person will recognise that the above described methods typically correspond to the normal measurement of the remaining fuel level in a vehicle fitted with a fuel tank, liquid level sensor apparatus and/or support structure of the present invention. Indeed, in some embodiments the fuel tanks of the present invention may be fitted into vehicles that were originally provided with prior art fuel tanks. In these embodiments the sender unit may be calibrated to output a substantially equivalent signal to the sender unit or units in the prior art assembly for an equivalent fuel level.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a plan view of a vehicle comprising a fuel tank of the saddle-tank type, comprising a fuel level sensor apparatus according to an embodiment of the invention;

FIG. 2 is a perspective view of a fuel level sensor apparatus according to an embodiment of the invention;

FIG. 3 is a perspective view of the fuel level sensor apparatus of FIG. 2, wherein a balance arm has been removed to aid illustration of other features of the fuel level sensor apparatus;

FIG. 4 is a partially exploded view of the fuel level sensor apparatus of FIG. 2;

FIG. 5 is a schematic representation of a fuel level sensor apparatus according to various embodiments of the invention, when both fuel compartments of a two-compartment fuel tank are at a lowest level or empty;

FIG. 6 is a schematic representation of a fuel level sensor apparatus according to various embodiments of the invention when both a passive (second) compartment of a two-compartment fuel tank and an active (first) compartment of the fuel tank are partially full;

FIG. 7 is a schematic representation of a fuel level sensor apparatus according to various embodiments of the invention when both a passive (second) compartment of a two-compartment fuel tank and an active (first) compartment of the fuel tank are full; and

FIG. 8 is a front view of a fuel level sensor apparatus according to another embodiment of the invention.

### DETAILED DESCRIPTION OF EMBODIMENTS

Detailed descriptions of specific embodiments of the liquid level sensor apparatus, fuel tanks, support structures and vehicles of the present invention are disclosed herein. It will be understood that the disclosed embodiments are merely examples of the way in which certain aspects of the invention can be implemented and do not represent an exhaustive list of all of the ways the invention may be embodied. Indeed, it will be understood that the liquid level sensor apparatus, fuel tanks, support structures and vehicles described herein may be embodied in various and alternative forms. The Figures are not necessarily to scale and some features may be exaggerated or minimised to show details of particular components. Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

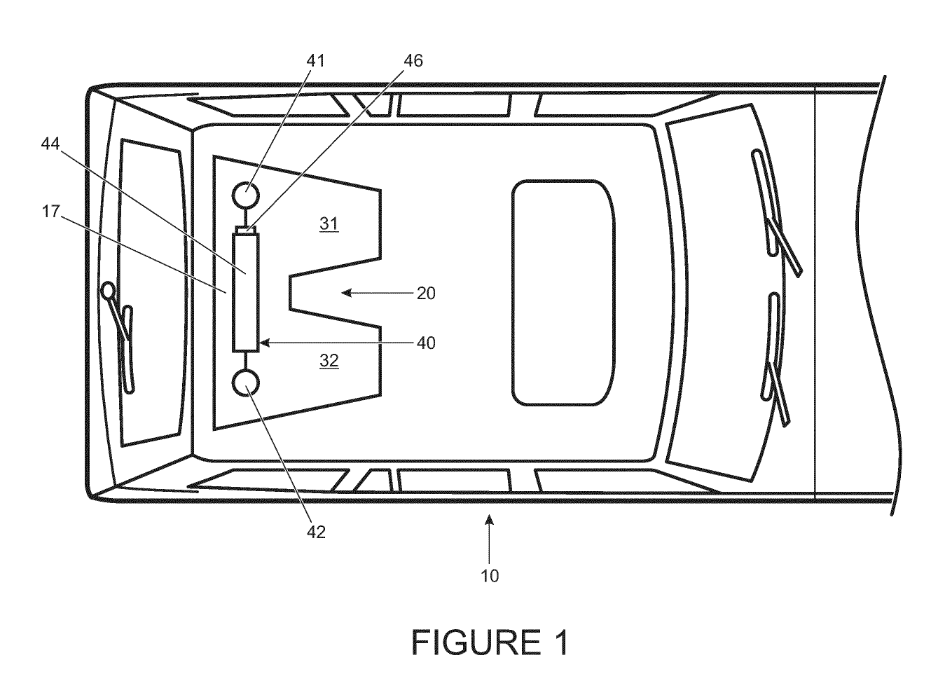

In FIG. 1 a vehicle 10 is illustrated having a fuel tank 20. The fuel tank 20 is of the “saddle tank” type, meaning that it has two fuel compartments 31, 32 connected by a saddle area or passageway 17 that is relatively narrow in depth (section) and/or width. The fuel tank 20 is installed beneath and in the region of the rear passenger seats of the vehicle 10 (which have been omitted from the illustration of FIG. 1 to aid the clarity of showing the fuel tank 20).

A first fuel compartment 31 optionally comprises a fuel delivery pump (not shown), and a sealable access means (not shown) is optionally provided to enable servicing and maintenance of the fuel level sensor apparatus 40 (including a sender unit 46 thereof) should it be required. The first fuel compartment 31 may also be referred to as an “active compartment” 31. A second fuel compartment 32 may not comprise any sealable access means or other plugged holes or apertures. The second fuel compartment 32 may be referred to as a “passive compartment” 32.

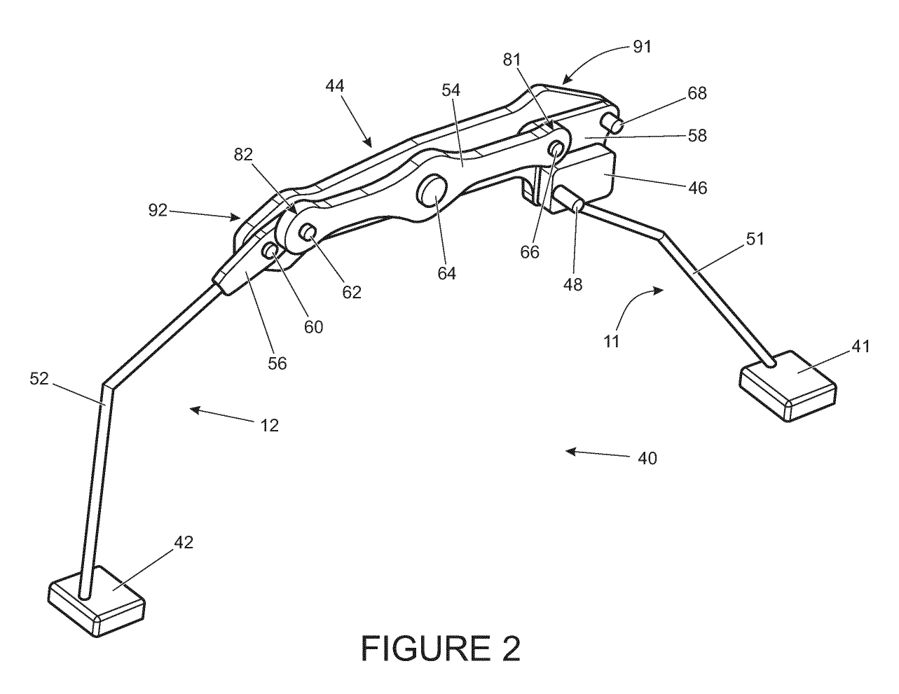

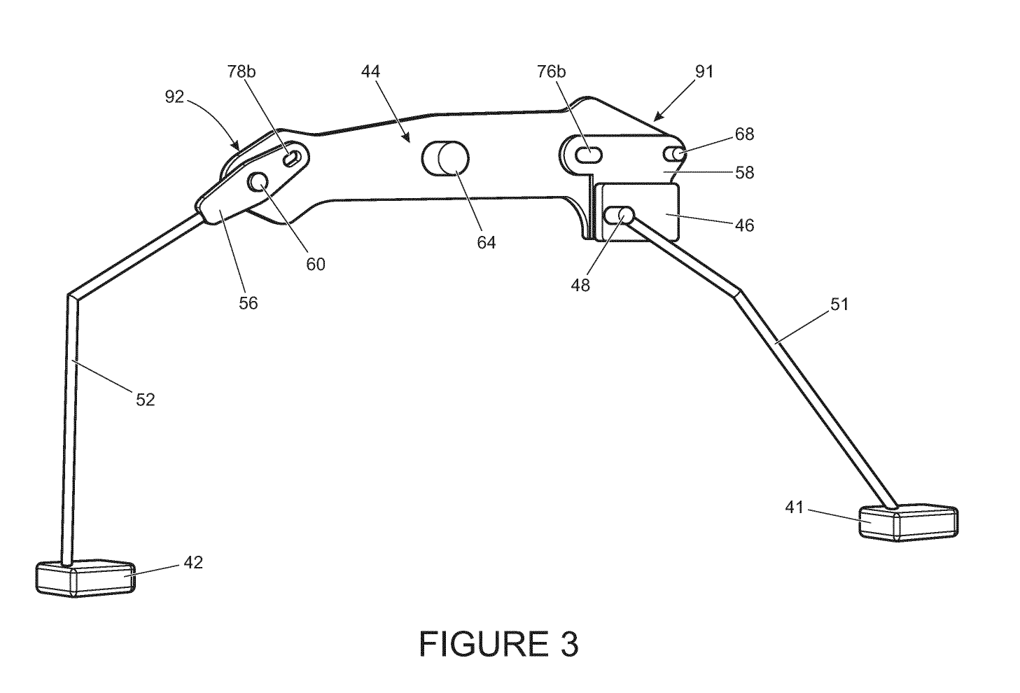

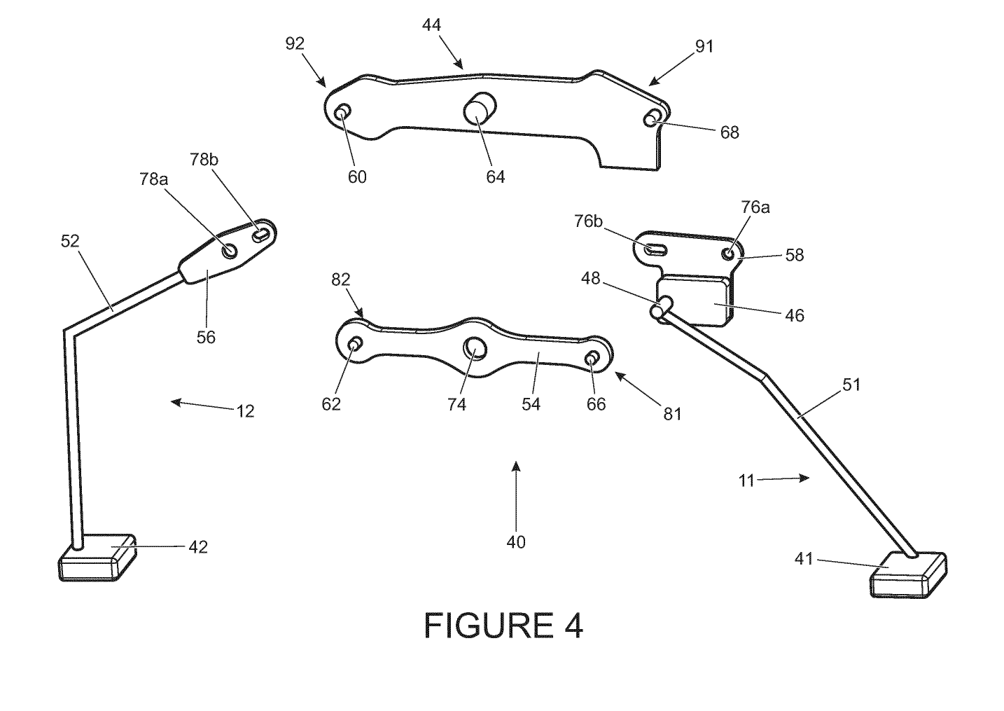

A fuel level sensor apparatus 40 according to an embodiment of the disclosure and as shown in more detail in FIGS. 2-4, is fitted within the fuel tank 20. The fuel level sensor apparatus 40 comprises: a support structure 44; a sender unit 46; a balance arm 54; a first float assembly 11; and a second float assembly 12. An exploded view of the primary components of the fuel level sensor 40 is provided in FIG. 4.

The support structure 44 is configured, shaped, sized and/or otherwise arranged to span the passageway 17. A portion or first end 91 of the support structure 44 is positionable proximate to the active compartment 31, and a second portion or second end 92 of the support structure 44 is positionable proximate to the passive compartment 32. The support structure 44 is fixedly attachable to an interior of a fuel tank 20 and provides means by which the fuel level sensor apparatus 40 can be securely installed. As such, the support structure 44 provides a non-moving part of the fuel level sensor apparatus 40 and therefore, pins 60, 64, 68 which form fixed pivots for other moveable components of the fuel level sensor apparatus 40 (as described below) are mounted to the support structure 44. Pins 60, 64, 68 may be integral formations of the support structure 44 or may be affixed thereto.

The sender unit 46 comprises electrical circuitry (not shown) configured to issue an electrical signal indicative of a total quantity of liquid or a level of liquid held in the tank 20. In the present embodiment, the electrical circuitry optionally comprises a resistive potentiometer. An actuator 48 (also referred to as knob 48 or arm 48) couples onto the resistive potentiometer and serves to operate a wiper (a slidably moveable electrical contact) of the resistive potentiometer. As such, a characteristic of the electrical circuitry changes in dependence upon the position of the actuator 48. In the present embodiment, a voltage output by the potentiometer changes in response to the position of the actuator 48.

The sender unit 46 comprises an outer casing, and the actuator 48 extends outwardly of the outer casing and/or is moveable relative thereto. The sender unit 46 may contact or be submerged in liquid (fuel) and as such the outer casing serves to encase the electric circuitry. An exposed part of the actuator 48 is coupled to an internal wiper that is in electrical contact with the potentiometer such that rotational movement of the actuator 48 causes a change in resistance, which is observable, for example, by monitoring the output voltage signal issued by the sender unit 46. In other embodiments, it is envisaged that other forms of suitable sender unit may be utilised. For example, in other embodiments the sender unit comprises a passively, magnetically actuated array of resistors and the actuator (wiper) thereof comprises a magnetic or ferrous material, movement of which, in a contactless manner, can cause a change in an electrical characteristic. Such sender units are currently available commercially, for example, Continental AG supplies “MAPPS” (Magnetic Passive Position Sensor) sender units.

A housing assembly 58 for the sender unit 46 is optionally provided. The sender unit 46 is rigidly affixed to the housing assembly 58 such that movement of the housing assembly causes movement of the sender unit 46. The housing assembly 58 comprises a substantially elongate or slot-shaped aperture 76b which, in combination with pin 66 within the first end 81 of the balance arm 54, forms a moving pivot. The housing assembly 58 comprises a substantially circular aperture 76a which forms a fixed pivot with pin 68 on the first end 91 of the support frame 44. It will be recognised that in other embodiments, the outer casing of the sender unit 46 may be adapted and arranged such that it integrally provides means by which it can be pivotally mounted as described and as such the provision of a separate housing assembly 58 is optional.

The balance arm 54 has a first end 81 proximate to the active compartment 31 and a second end 82 proximate to the passive compartment 32. The balance arm 54 comprises a substantially centrally positioned and optionally circular shaped aperture 74 (see FIG. 4) and two pins 62, 66 at second and first ends 82, 81 thereof for forming moving pivots (as described below). The balance arm 54 is mounted via aperture 74 and pin 64 to the support structure 44. Pin 64 may have a shaped head or head fixing (not shown) so as to prevent the balance arm 54 from sliding off the pin 64. The positioning of the fixed pivot 64/74 is determined in dependence upon the geometry of the fuel tank 20 in which the fuel level sensor apparatus 40 is installed and the configuration of the balance arm 54. In other embodiments the balance arm 54 may have a different shape, size and configuration to that illustrated. Nevertheless, the fixed pivot 64, 74 is disposed at least substantially centrally between the first and second ends 81, 82 of the balance arm 54.

The first float assembly 11 comprises a first float 41 attached to a first float arm or rigid tether 51. The configuration of the first float assembly 11 enables the first float 41 to sit or float on a first surface 71 of the liquid (fuel) air interface in the first active compartment 31. The first surface 71 may also be referred to herein as a “first level” or “first liquid level”.

A first end of the first float arm 51 is connected, affixed or otherwise attached to the first float 41; and a second end of the first float arm 51 is attached, affixed, integrally formed with or otherwise connectable to the actuator 48 of the sender unit 46. In this way movement of the first float 41, with the rise and fall of liquid fuel in the active compartment 31, causes movement of the actuator 48. The first float assembly 11 is arranged such that when the fuel level increases and the first float 41 rises, the actuator 48 is rotated in an actuator first direction. Conversely, when the fuel level 71 decreases and the first float 41 drops, the actuator 48 is rotated in an actuator second direction.

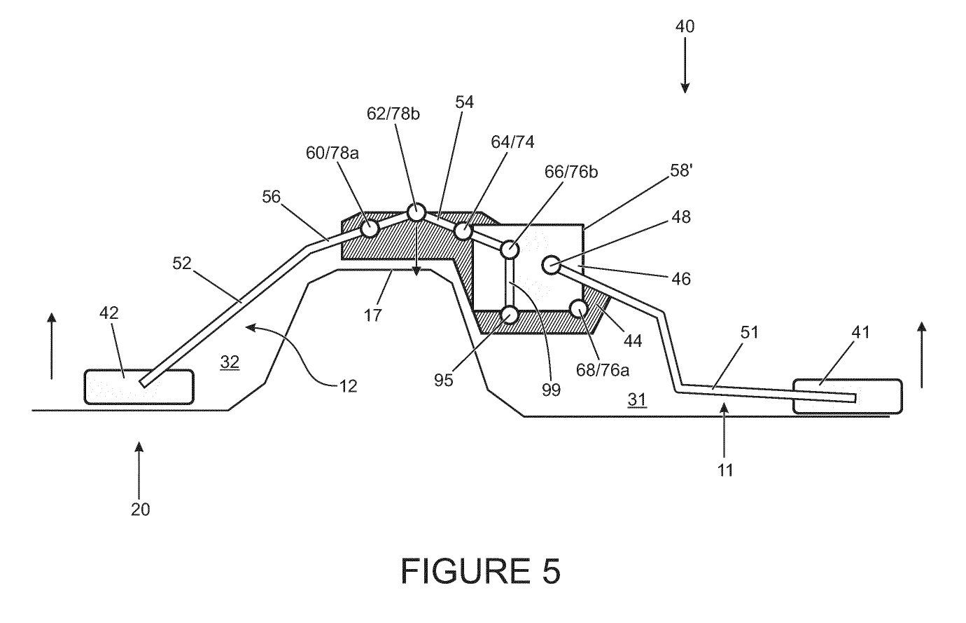

The second float assembly 12 comprises a second float 42 attached to a second float arm 52 or rigid tether 52. The configuration of the second float assembly enables the second float 42 to sit or float on a second surface 72 of the liquid (fuel) air interface in the second passive compartment 32. The second surface 72 may also be referred to herein as a “second level” or “second liquid level”. The positioning of the first and second floats 41, 42 in response to changing first and second levels of liquid (fuel) 71, 72 is illustrated schematically in FIGS. 5 to 7.

The second float assembly 12 is connectable to a float arm 56. As is best seen in FIG. 4, the float arm 56 comprises two apertures 78a, 78b. Aperture 78b forms a moving pivot with pin 62 provided on the second end 82 of the balance arm 54; and aperture 78a, forms a fixed pivot with pin 60 provided on the support frame 44. Aperture 78a optionally has a substantially circular cross-sectional shape. Aperture 78b, which forms part of a moving pivot, optionally has a substantially slot-shaped cross-section (in other words, elongate or “race-track”-shaped) which allows the float arm 56 to be coupled to the balance arm 54 by a moving pivotal connection 78b/62.

The assembled fuel level sensor apparatus 40 is shown in FIG. 2 wherein it can be seen that the housing assembly 58 is pivotally coupled to both the first end 91 of the support frame 44 (via fixed pivot 68/76a) and to the first end 81 of the balance arm 54 (via moving pivot 66/76b). The first float assembly 11 is coupled to the actuator 48 of the sender unit 46. At the other end of the fuel level sensor apparatus 40, the second float assembly 12 is connected to the float arm 56 and is coupled to both the second end 92 of the support frame 44 (via fixed pivot 60/78a) and to the second end 82 of the balance arm 54 (via moving pivot 62/78b).

In alternative optional arrangements, one or more drop arms 99 (not shown in FIGS. 2-4 but see FIGS. 5-8, which show a single drop arm 99, 199 respectively) may be provided between the first end of the balance arm 54 (or 154) and a sender unit housing assembly 58′ (or 158). A drop arm is a rigid linking arm. In the schematic illustrations showing the embodiment of FIGS. 5-7, the housing unit 58′ is not configured as shown in FIGS. 2-4. Rather than the housing unit 58′ being directly pivotally connected to the first end of the balance arm 54, the drop arm 99 is pivotally connected to the first end 81 of the balance arm 54 and is then pivotally connected to the housing assembly 58′ by a moving pivot connection 95 in order to cause rotational movement of the sender unit 46. The drop arm 99 is thereby used to cause the sender unit 46 to adopt the correct position for the float pivot height to enable adjustment for differing tank heights and float arm 56 lengths.

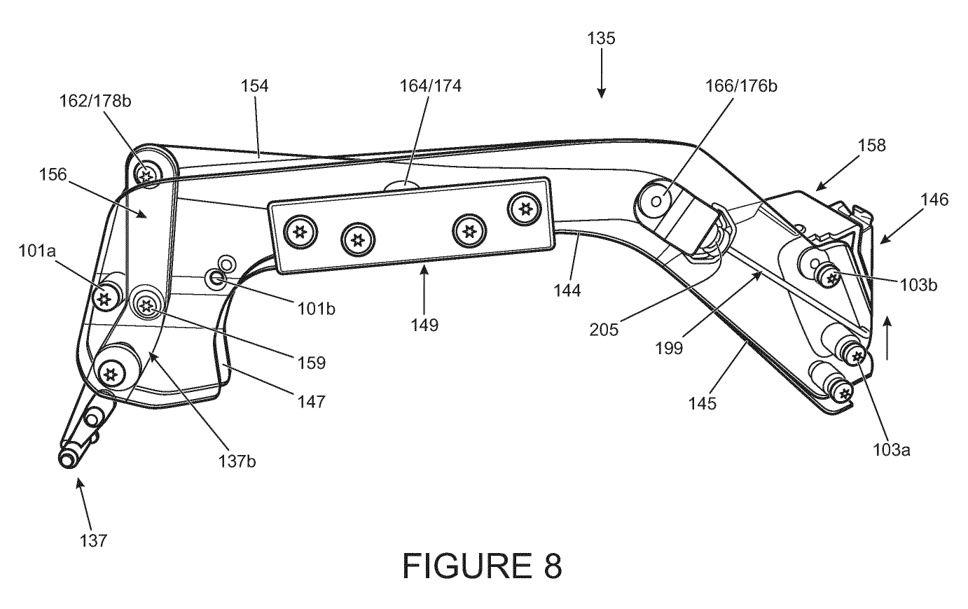

In other embodiments, an active side drop arm is pivotally connected to the first end 81 of the balance arm 54 and is then connected to the sender unit 46 or, as in FIG. 8 and as described below, the drop arm 199 directly contacts the sender unit 146 in order to cause rotational movement of the sender unit 146. The one or more active side drop arm(s) 199 can have any appropriate length.

Operation of the fuel level sensor apparatus 40 having a single (active side) drop arm 99 connected to a housing assembly 58′ (only shown schematically) is now described with reference to schematic illustrations of FIGS. 5 to 7. Since all other features shown are the same as the embodiment of FIGS. 1-4, the reference numerals used in FIGS. 1-4 will be adhered to in FIGS. 5-7 albeit with the inclusion of 99 to denote the additional drop arm and with the use of 58′ to denote the housing assembly.

In FIG. 5 it can be seen that a partially illustrated fuel tank 20 has both an “empty” active compartment 31 and an “empty” passive compartment 32. In automotive vehicles it is preferred that fuel tanks are not permitted to reach an absolutely empty level (indeed it is the purpose of the present invention to provide for accurate monitoring of fuel level so that a fuel tank becoming completely empty can be avoided). Nevertheless, for the purposes of explaining the operation of the fuel level sensor apparatus 40 provided by the present disclosure, an example is provided in FIG. 5 which shows the first and second floats 41, 42 positioned at their lowest possible positions, which represent the lowest liquid levels 71, 72 that the first and second floats can sense.

In FIG. 5 it can be seen that the arrangement of links and pivots in the fuel level sensor apparatus 40 allows the housing assembly 58′ for the sender unit 46 to adopt a stop or rest position when the second, passive float 42 is in a “low position”. The “low position” is predetermined to represent an empty or near-empty passive compartment 32. This then allows the active, first float 41 to detect the level of fuel in the active compartment 31 of the fuel tank. A “low position” of the first active float 41 is predetermined to represent an “empty” or near-empty active compartment 31.

When the fuel level in the passive compartment 32 increases, the second, passive float 42 rises (see arrow next to float 42 in FIG. 5). The second float 42 rising, causes one end of the float arm 56 to rise. Due to the float arm 56 being connected to the support frame 44 via a fixed pivot 60/78a, the other end of the float arm 56 drops. Due to the moving pivot connection 62/78b between the dropping end of the float arm 56 and the second end 82 of the balance arm 54, the second end of the balance arm 54 also drops (see arrow in FIG. 5). This then causes the balance arm 54 to pivot (about fixed pivot 64/74), which causes the first end 81 of the balance arm 54 to be raised. This in turn raises the drop arm 99 and due to the moving pivotal connection 95 between the drop arm 99 and the housing assembly 58′, the corner of the housing assembly 58′ (proximate pivot 95) is raised. Due to the fixed pivotal connection 68/76a, the housing assembly 58′ and hence sender unit 46 is rotated clockwise as shown in FIG. 5.

The actuator 48, by virtue of its direct connection to the first float 41, moves rotationally relative to sender unit 46 if first float 41 moves relative to the sender unit 46 or, as in this case, vice versa, and effectively, in this example, by moving the sender unit 46 clockwise relative to float 41 and thus the actuator 48 effectively anti-clockwise relative to the sender unit 46, the electrical contact is moved relative to the wiper of the potentiometer. Thus additional fuel content can be registered using a single potentiometer. Additionally or alternatively, when the position of the active float 41 is raised (see arrow near to float 41 in FIG. 5) due to the presence of an increased fuel level in the active compartment 31, the actuator 48 is directly moved (effectively further anti-clockwise relative to the sender unit 46) and by further moving the wiper of the potentiometer relative to the electrical contact in the correct direction, further additional fuel content is registered using the single sender unit 46.

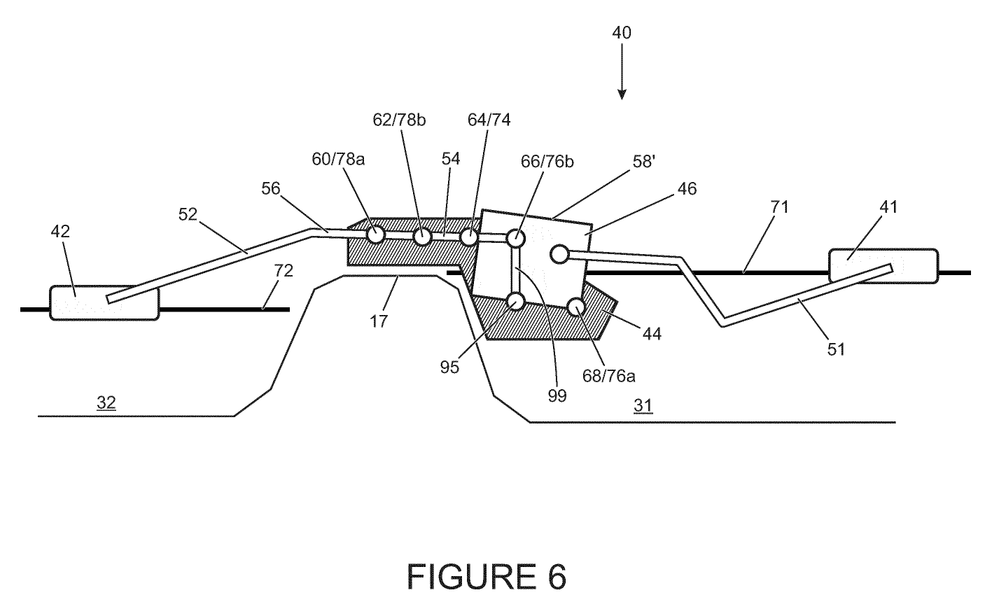

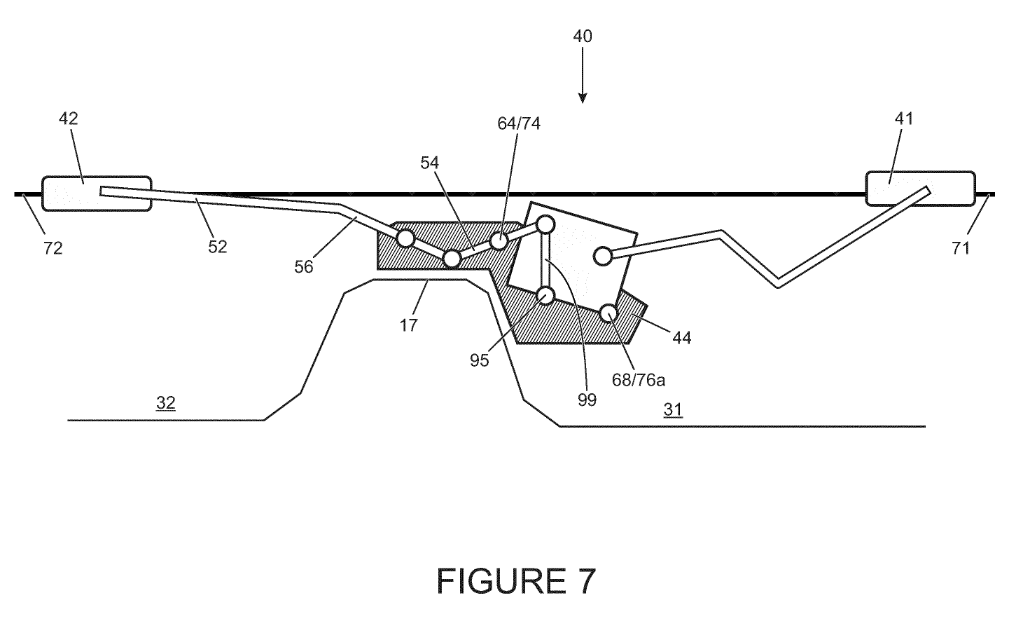

In FIG. 6, a position of the fuel level sensor assembly 40, when both the first and second floats 41, 42 are floating on increased first and second fuel levels 71, 72 (compared to the situation in FIG. 5), is shown. A position of the fuel level sensor assembly 40 when both the first and second floats 41, 42 are floating on maximum registrable first and second fuel levels 71, 72 is shown in FIG. 7.

In will be appreciated that the actuator 48 may have a range of movement corresponding to a range of electrical outputs. Optionally, the actuator 48 may have a 90° range of rotational movement, and this range of movement can be affected by changes in fuel level and thus can cause a range of electrical signals to be issued dependent upon fuel level. In the present arrangement, the range of movement of the actuator 48 is shared by the first and second float assemblies 11, 12. The proportion of the full potentiometer angular movement range to be usable by the first and second float assemblies detecting fuel levels in each compartment of the fuel tank 20 may be calibrateable.

Referring now to FIG. 8, there is shown an alternative embodiment of the present invention. In the alternative illustrated embodiment like numerals have, where possible, been used to denote like parts, albeit with the addition of the prefix “100” to indicate that these features belong to the alternative illustrated embodiments. The alternative embodiments share many common features with the embodiments of FIGS. 1 to 7 and therefore only the differences from the embodiments illustrated in FIGS. 1 to 7 will be described in any greater detail.

In FIG. 8, a support structure 135 for use in a fuel level sensor apparatus is shown. In this arrangement the support frame 144 comprises a first leg portion 145 for being positioned in the active compartment; a medial portion 149 that spans the saddle point 17; and a second leg 147 for positioning in the passive compartment. The support structure 135 further comprises a drop arm 156 that is pivotally coupled to the balance arm 154 at pivot point 162/178b. As shown, the drop arm 156 is linked, via a moving pivot 159 to a passive side float arm lever 137b, which may form part of a second float assembly having a link or connection 137 (not fully shown). Beneficially, the second leg 147 comprises first and second stops 101a, 101b. The two stops 101a, 101b limit the range of movement of the second float assembly and/or drop arm 156 (and hence balance arm 154) between a first start position and a first stop position.

In FIG. 8, an articulating means, optionally in the form of a ball joint connection 205 between a drop arm 199 and the balance arm 154 is provided and allows an active (first) float (not shown in FIG. 8) to operate in a variety of planes. The drop arm 199 is shaped so that it securely contacts and engages a portion of the sender unit 146 or sender unit housing 158. As such, the drop arm 199 has a contacting end portion that is shaped and configured in a complementary manner so that it mates with the sender unit 146 or sender unit housing 158 to effect movement thereof. Additionally, the provision of a jointed end or “L”-shaped end portion on the drop arm 199 enables the sender unit 146 and sender unit housing 158 to be compactly packaged and be mounted at an angle relative to the drop arm 199. As such, the sender unit 146 or, if provided, a sender unit housing 158 is not necessarily positioned “in line” with the direction of travel of the drop arm 199 and/or balance arm 154. The support structure 135 further comprises two stops 103a, 103b for limiting the range of movement of the drop arm 199 so that the range of movement of the sender unit 146 and/or sender unit housing 158 is limited between a “sender unit start position” and a “sender unit stop position”.

The support structure 135 may be assembled into a fuel level sensor apparatus with the first and second float assemblies either before or after installation of the support structure 135 into a fuel tank.

In some embodiments the actuator 48 of the sender unit may be referred to as a first part of the sender unit, and the remainder of the sender unit (i.e. all of the sender unit apart from the actuator 48) may be referred to as a body of the sender unit, or as a second part of the sender unit. The skilled person will recognise that although the illustrated embodiment shows the actuator coupled to the float assembly disposed in the active compartment embodiments in which the body of the sender unit are coupled to the float assembly disposed in the active compartment are also possible.

The sender unit in the illustrated embodiment may be configured to issue a signal in dependence on the rotational position of the first part of the sender unit (i.e. the actuator 48) relative to that of the second part of the sender unit (i.e. the body of the sender unit).

However, the skilled person will understand that other embodiments in which the relative movement between the first and second parts of the sender unit is not rotation would also be possible. For example, the first and second parts may translate relative to one another in response to movement of the first and/or second float assemblies.

It can be appreciated that various changes may be made within the scope of the present invention. For example, the arrangement of pivotal links and drop arms may take a variety of forms in order to provide a mechanical connection between a second float assembly that bridges or spans a saddle weir area 17 to couple to a device positioned in the active compartment, which device is capable of translating movement of the second float, in dependence upon the fuel level in the passive compartment, into an electrical signal.

In other embodiments it is envisaged that the balance arm may be linearly moveable rather than pivotally moveable.

In other envisaged embodiments, the second float assembly is coupled mechanically to a second sender unit comprised in the active compartment. The second sender unit may be dedicated to monitoring the fuel level in the passive compartment. Such an arrangement, whilst less advantageous in terms of cost-saving (because two sender units are required rather than only one), is nevertheless beneficial because servicing and repair can be carried out via an access means provided in the active side and may be beneficial because separate data signals indicative of the first and second fuel levels are issued.

In embodiments of the invention it is envisaged that the actuator forms part of the electrical circuitry, for example the actuator forms part of a potentiometer. In other embodiments, an internal aspect of the actuator is in electrical contact with the resistive potentiometer. In other envisaged embodiments, the electrical circuitry comprised within the sender unit may be otherwise configured such that it can output an electrical signal characteristic of a position of the actuator.

As used herein the term “potentiometer” is not necessarily limited to meaning a traditional contact-type resistive potentiometer and may be interpreted to mean a contactless and/or magnetic form of potentiometer.

In yet further envisaged embodiments, the electrical circuitry may comprise electrical components other than a potentiometer provided that an electrical characteristic of the electrical circuitry changes in dependence upon the position of the actuator.

In other envisaged embodiments a position of the actuator may be adjusted or changed by movement other than rotational movement. For example, in other arrangements, the actuator is linearly moveable or depressed and movement of the first and second float assemblies, with increasing liquid level, increases the extent to which the actuator is moved or depressed and vice versa.

In envisaged embodiments, the support structure and/or other components of the fuel level sensor apparatus may be integrally formed as part of the moulded structure of the fuel tank. It will be appreciated that the support structure may take a variety of forms and may be formed of separate sections, each separately attached to the fuel tank and each thereby providing a fixed pivot point for the second float assembly, balance arm and sender unit or sender unit housing or rigid link arm.

The following numbered paragraphs contain statements of invention:
1. A liquid level sensor apparatus for use in a fuel tank for determining a level or quantity of fuel therein, the liquid level sensor apparatus comprising:
   (i) a sender unit having electrical circuitry and an actuator coupled thereto, the sender unit being configured to issue an electrical signal indicative of a level or quantity of liquid;
   (ii) a first float assembly moveable in response to a first liquid level and being coupled directly to the actuator for the electrical circuitry such that in response to movement of the first float assembly the actuator is moved and a characteristic of the electrical circuitry is affected; and
   (iii) a second float assembly moveable in response to a second liquid level and being indirectly coupled to the sender unit such that movement of the second float assembly causes movement of the sender unit and thereby said characteristic of the electrical circuitry is affected.
2. A liquid level sensor apparatus according to paragraph 1 wherein the sender unit comprises a single actuator such that changes in first and second liquid levels are translated into a change in an electrical characteristic by a single sender unit and wherein said sender unit is configured to issue an electrical signal indicative of a quantity of liquid.
3. A liquid level sensor apparatus according to paragraph 2 wherein the actuator is a wiper of a potentiometer or is attached to a wiper of a potentiometer and wherein the wiper is slidably and electrically in contact with the electrical circuitry.
4. A liquid level sensor apparatus according to paragraph 2 wherein movement of the actuator creates or changes a magnetic field within the sender unit or wherein the actuator is connected to a wiper and movement of the wiper creates or changes a magnetic field within the sender unit.
5. A liquid level sensor apparatus according to paragraph 1 wherein the actuator is rotatable and wherein the sender unit is rotatable or wherein the actuator is linearly moveable and wherein the sender unit it linearly moveable.
6. A liquid level sensor apparatus according to paragraph 5 wherein, in response to an increase in the first liquid level, the first float assembly causes the actuator to move in a first actuator direction; and wherein, in response to an increase in the second liquid level, the second float assembly causes the actuator to move also in the first actuator direction.
7. A liquid level sensor apparatus according to paragraph 6 wherein the sender unit is pivotally mounted within the fuel sensor apparatus and is rotatably moveable between a first sender unit position and a second sender unit position.
8. A liquid level sensor apparatus according to paragraph 7 wherein a sender unit is rigidly affixed to a housing assembly and the housing assembly is rotatable and thereby the sender unit is rotatably moveable between a first sender unit position and a second sender unit position.
9. A liquid level sensor apparatus according to paragraph 8 comprising a balance arm having first and second ends and being shaped and arranged for spanning between first and second fuel compartments of a fuel tank, wherein the balance arm is pivotally mounted within the liquid level sensor apparatus, wherein the second float assembly is rigidly coupled to the second end of the balance arm and wherein the first end of the balance arm is coupled to the sender unit such that movement of the second float assembly in dependence upon the second liquid level causes movement of: the second end of the balance arm; the first end of the balance arm; and the position of the sender unit relative to the actuator.
10. A liquid level sensor apparatus according to paragraph 9 comprising a support frame shaped and arranged for spanning between first and second fuel compartments of a fuel tank.
11. A liquid level sensor apparatus according to paragraph 10 wherein the balance arm is pivotally mounted to the support frame, wherein the sender unit housing assembly is pivotally mounted to the support frame and wherein a rigid link arm is coupled to the first end of the balance arm.
12. A liquid level sensor apparatus according to paragraph 11 wherein the rigid link arm is coupled to the first end of the balance arm via an articulating joint and is positioned and arranged such that movement of the first end of the balance arm causes movement of the rigid link arm which in turn contacts and thereby moves the sender unit housing assembly or sender unit, which in turn causes movement of the actuator relative to the first float assembly.
13. A liquid level sensor apparatus according to paragraph 12 further comprising two stops for limiting the range of movement of the second float assembly between a first start position and a first stop position; and/or further comprising two stops for limiting the range of movement of the sender unit between a sender unit start position and a sender unit stop position.
14. A liquid level sensor apparatus according to paragraph 13 wherein the support frame comprises a main member to which the balance arm is pivotally mounted; a first leg for being positioned within a first compartment of a fuel tank; and a second leg for being positioned within a second compartment of a fuel tank, wherein the two stops for limiting the range of movement of the second float assembly are affixed to the second leg of the support frame; and/or wherein the two stops for limiting the range of movement of the sender unit are affixed to the first leg of the support frame.
15. A support structure for use in a liquid level sensor apparatus according to paragraph 1, the support structure comprising:
   (i) a support frame having a main member; a first leg for being positioned at a first location within a fuel tank; and a second leg for being positioned at a second location within a fuel tank;
   (ii) a balance arm pivotally mounted to the main member of the support frame;
   (iii) a sender unit housing assembly pivotally mounted to or proximate to the second leg of the support frame; and
   (iv) a rigid link arm coupled to the first end of the balance arm via an articulating joint and positioned and arranged such that movement of the first end of the balance arm causes movement of the rigid link arm which in turn contacts and thereby moves the sender unit housing assembly or sender unit.
16. A support structure according to paragraph 15 further comprising:
   (i) two stops affixed to the second leg of the support frame for limiting the range of movement of the second float assembly between a first start position and a first stop position; and/or
   (ii) a further two stops are affixed to the first leg of the support frame for limiting the range of movement of the sender unit housing assembly between a sender unit start position and a sender unit stop position.
17. A fuel tank for a vehicle comprising a liquid level sensor apparatus according to paragraph 1.
18. A fuel tank for a vehicle according to paragraph 17, the fuel tank of the saddle tank type and comprising a first fuel compartment connected to a second fuel compartment.
19. A fuel tank for a vehicle according to paragraph 18 wherein the first fuel compartment comprises a sealable access means and wherein the second fuel compartment does not comprise an access means and wherein the liquid level sensor apparatus is affixed to the fuel tank such that the first float assembly and sender unit are disposed within the first fuel compartment and such that the second float assembly is disposed within the second fuel compartment.
20. A vehicle comprising a liquid level sensor apparatus according paragraph 1.
21. A vehicle comprising a fuel tank according to paragraph 1.

1. A liquid level sensor apparatus for determining a level or quantity of liquid in a tank, the liquid level sensor apparatus comprising:
(i) means for issuing a signal indicative of the level or quantity of liquid;
(ii) a first float assembly moveable in response to a first liquid level and being coupled directly to said means such that in response to movement of the first float assembly a characteristic of said means is affected and a signal issued by said means is indicative of said first liquid level; and
(iii) a second float assembly moveable in response to a second liquid level and being in-directly coupled to said means such that in response to movement of the second float assembly a characteristic of said means is affected and a signal issued by said means is indicative of said second liquid level.

2. A liquid level sensor apparatus according to claim 1 wherein said first float assembly is positionable at a first location, said second float assembly is positionable at a second location spaced from said first location and said second float assembly is in-directly coupled to said means via a mechanical linkage structure that is structured and arranged for spanning at least partially between said first and second locations.

3. A liquid level sensor apparatus according to claim 2 wherein said first location is in a first liquid compartment and wherein said second location is in a second liquid compartment and said mechanical linkage structure is structured and arranged for spanning at least partially between the first and second liquid compartments.

4. A liquid level sensor apparatus according to claim 1 wherein said means for issuing an electrical signal comprises a sender unit having electrical circuitry and an actuator coupled thereto, the sender unit being configured to issue said electrical signal; wherein said first float assembly is coupled directly to the actuator for the electrical circuitry such that in response to movement of the first float assembly the actuator is moved and a change in a characteristic of the electrical circuitry is registered; and wherein said second float assembly is indirectly coupled to the sender unit such that in response to movement of the second float assembly, the sender unit is moved and thereby a change to an electrical characteristic of the electrical circuitry is registered.

5. A liquid level sensor apparatus according to claim 4 wherein the sender unit comprises a single actuator, such that changes in first and second liquid levels are translated into a change in an electrical characteristic by a single sender unit and wherein said sender unit is configured to issue an electrical signal indicative of a quantity of liquid.

6. A liquid level sensor apparatus according to claim 5 wherein the actuator is a wiper of a potentiometer or is attached to a wiper of a potentiometer and wherein the wiper is slidably and electrically in contact with the electrical circuitry.

7. A liquid level sensor apparatus according to claim 5 wherein movement of the actuator creates or changes a magnetic field within the sender unit, or the actuator is connected to a wiper and movement of the wiper creates or changes a magnetic field within the sender unit.

8. A liquid level sensor apparatus according to claim 4 wherein the actuator is rotatable and the sender unit is rotatable or wherein the actuator is linearly moveable and the sender unit is linearly moveable.

9. A liquid level sensor apparatus according to claim 8 wherein, in response to an increase in the first liquid level, the first float assembly causes the actuator to move in a first actuator direction; and wherein, in response to an increase in the second liquid level, the second float assembly causes the actuator to move also in the first actuator direction.

10. A liquid level sensor apparatus according to claim 8 wherein the sender unit is pivotally mounted within the sensor apparatus and is rotatably moveable between a first sender unit position and a second sender unit position.

11. A liquid level sensor apparatus according to claim 10 wherein a sender unit is rigidly affixed to a housing assembly and the housing assembly is rotatable and thereby the sender unit is rotatably moveable between a first sender unit position and a second sender unit position.

12. A liquid level sensor apparatus according to claim 11 comprising a balance arm having first and second ends and being shaped and arranged for spanning between first and second compartments of a tank, wherein the balance arm is pivotally mounted within the liquid level sensor apparatus, wherein the second float assembly is rigidly coupled to the second end of the balance arm and wherein the first end of the balance arm is coupled to the sender unit such that movement of the second float assembly in dependence upon the second liquid level causes movement of: the second end of the balance arm; the first end of the balance arm; and the position of the sender unit relative to the actuator.

13. A liquid level sensor apparatus according to claim 12 comprising a support frame shaped and arranged for spanning between first and second compartments of a tank.

14. A liquid level sensor apparatus according to claim 13 wherein the balance arm is pivotally mounted to the support frame and wherein the sender unit housing assembly is pivotally mounted to the support frame.

15. A liquid level sensor apparatus according to claim 14 further comprising a rigid link arm coupled to the first end of the balance arm via an articulating means and positioned and arranged such that movement of the first end of the balance arm causes movement of the rigid link arm which in turn contacts and thereby moves the sender unit housing assembly or sender unit, which in turn causes movement of the actuator relative to the first float assembly.

16. A liquid level sensor apparatus according to claim 15 wherein the articulating means is a ball joint or a pivot.

17. A liquid level sensor apparatus according to claim 1 further comprising at least one of (i) two stops for limiting the range of movement of the second float assembly between a first start position and a first stop position; and (ii) two stops for limiting the range of movement of the sender unit between a sender unit start position and a sender unit stop position.

18. A liquid level sensor apparatus according to claim 14 wherein the support frame comprises a main member to which the balance arm is pivotally mounted; a first leg for being positioned within a first compartment of a tank; and a second leg for being positioned within a second compartment of a tank, two stops for limiting a range of movement of the second float assembly, the two stops being affixed to the second leg of the support frame; and two stops for limiting a range of movement of the sender unit affixed to the first leg of the support frame.

19. A liquid level sensor apparatus according to claim 1 wherein the first float assembly comprises a first float attached to a first rigid tether; wherein the second float assembly comprises a second float attached to a second rigid tether.

20. A support structure for use in a liquid level sensor apparatus according to claim 1, the support structure comprising:
(i) a support frame shaped and arranged for spanning between a first and a second compartment of a tank and having a main member; a first leg for being positioned within the first compartment of the tank; and a second leg for being positioned within the second compartment of the tank;
(ii) a balance arm pivotally mounted to the main member of the support frame; and
(iii) a sender unit housing assembly pivotally mounted to or proximate to the second leg of the support frame.

21. A support structure according to claim 20 comprising a rigid link arm coupled to the first end of the balance arm via an articulating means and positioned and arranged such that movement of the first end of the balance arm causes movement of the rigid link arm which in turn contacts and thereby moves the sender unit housing assembly or sender unit.

22. A support structure according to claim 21 wherein the articulating means is a ball joint or pivot.

23. A support structure according to claim 16, further comprising at least of:
(i) two stops affixed to the second leg of the support frame for limiting the range of movement of the second float assembly between a first start position and a first stop position; and
(ii) two stops affixed to the first leg of the support frame for limiting the range of movement of the sender unit housing assembly between a sender unit start position and a sender unit stop position.

24. A fuel tank for a vehicle comprising a liquid level sensor apparatus according to claim 1.

25. A fuel tank for a vehicle according to claim 24 wherein the fuel tank is a saddle tank type comprising a first fuel compartment connected to a second fuel compartment.

26. A fuel tank for a vehicle according to claim 25 wherein the first fuel compartment comprises a sealable access means and wherein the second fuel compartment does not comprise an access means and wherein the liquid level sensor apparatus is affixed to the fuel tank such that the first float assembly and sender unit are disposed within the first fuel compartment and such that the second float assembly is disposed within the second fuel compartment.

27. A vehicle comprising a fuel tank according to claim 24.

28. A method for determining a level or quantity of liquid in a saddle-type fuel tank having an active compartment and a passive compartment, said active compartment and said passive compartment being connected via a passageway,
a liquid level sensor apparatus being disposed within the the tank and comprising a sender unit for issuing a signal indiative of the level or quantity of liquid, a first float assembly, and a second float assembly, the method comprising:
issuing a signal indicative of the level or quantity of liquid in the tank from said sender unit,
wherein:
the sender unit is disposed in the active compartment and comprises a first part and a second part, the sender unit being configured to issue a signal dependent upon the position of the first part and the second part;
the first float assembly is disposed in the active compartment and is movable in response to the liquid level in the active compartment;
the second float assembly is disposed in the passive compartment and is movable in response to the liquid level in the passive compartment; and
movement of the first float assembly is configured to affect the position of the first part of the sender unit and movement of the second float assembly is configured to affect the second part of the sender unit;
whereby the signal issued by the sender unit is indicative of the total level or quantity of liquid within said active compartment and said passive compartment.

29. A method as claimed in claim 28, wherein one of the first and second parts of the sender unit comprises a body of the sender unit, the other of the first and second parts of the sender unit comprises an actuator of the sender unit, and the sender unit is configured to issue a signal dependent on the relative positions of the actuator and the body.

30. A method as claimed in claim 28 wherein said movement of the first and second parts of the sender unit comprises rotation.

31. A method as claimed in claim 28, wherein the liquid level sensor apparatus further comprises a mechanical linkage structure disposed in said passageway and connected to at least said the second part of the sender unit and said second float assembly.

32. A method as claimed in claim 28, wherein one of said first and second float assemblies is directly coupled to said sender unit and one of said first and second float assemblies is indirectly coupled to said sender unit.

33. A saddle-type fuel tank having an active compartment and a passive compartment connected to said active compartment via a passageway, the fuel tank comprising an apparatus for determining the level or quantity of liquid within said fuel tank, the apparatus comprising:
a first float assembly located in the active compartment;
a second float assembly located in the passive compartment; and
a sender unit located in the active compartment and comprising a first part and a second part, the sender unit being configured to issue a signal dependent upon the positions of the first part and the second part,
wherein:
the first float assembly is movable in response to the liquid level in the active compartment;
the second float assembly is movable in response to the liquid level in the passive compartment; and
movement of the first float assembly is configured to affect the position of the first part of the sender unit and movement of the second float assembly is configured to affect the second part of the sender unit;
whereby the signal issued by the sender unit is indicative of the total level or quantity of liquid within said active compartment and said passive compartment.

34. A saddle-type fuel tank as claimed in claim 33, wherein one of the first and second parts of the sender unit comprises a body of the sender unit, the other of the first and second parts of the sender unit comprises an actuator of the sender unit, and the sender unit is configured to issue a signal dependent on the relative positions of the actuator and the body.

35. A saddle-type fuel tank as claimed in claim 33, wherein the movement of the first and second parts comprises rotation.

36. A saddle-type fuel tank as claimed in claim 33, further comprising a mechanical linkage structure disposed in said passageway and connected to at least said the second part of the sender unit and said second float assembly.

37. A saddle-type fuel tank as claimed in claim 36, wherein said mechanical linkage structure comprises a support structure and a balance arm pivotably connected thereto, the balance arm being further connected to the second part of the sender unit and the second float assembly.

38. A vehicle comprising a saddle-type fuel tank as claimed in claim 33.

39. A vehicle configured to implement a method as claimed in claim 28.

40. (canceled)
